(19) United States
(12) Patent Application Publication
(10) Pub. No.: US 2023/0161828 A1
(43) Pub. Date: May 25, 2023

(54) SYSTEM AND METHOD FOR RANKING ITEMS ON LIST

(71) Applicant: Arctic Alliance Europe Oy, Turku (FI)

(72) Inventor: Petri Nyman, Nummela (FI)

(73) Assignee: Arctic Alliance Europe Oy, Turku (FI)

(21) Appl. No.: 17/987,565

(22) Filed: Nov. 15, 2022

(30) Foreign Application Priority Data
Nov. 19, 2021 (FI) 20216187

(51) Int. Cl. G06F 16/9538

(52) U.S. Cl. CPC G06F 16/9538

(57) ABSTRACT

A method for ranking items in a list in view of a request (N1, N2). The method includes processing the request (N1, N2) to obtain a result set therefor, determining a distance between each of reference result sets of a plurality of reference entries (A, B, C, D, E, F, G, H, J) and the result set of the request, determining a weight value for each of the reference result sets of the plurality of reference entries based on a maximum distance from the determined distances for the reference result sets of the plurality of reference entries, and determining a rank score for each of the items in the list based on the weight values of the corresponding reference entries associated therewith.

### TECHNICAL FIELD

The present disclosure relates to ranking techniques; and more specifically to systems and methods for ranking items in a list in view of a request.

### BACKGROUND

In recent times, information is readily available electronically, via information repositories such as databases. Generally, databases are substantially unorganized collections of data, while databases are indexed in some fashion. For example, the Internet, the world's largest database, has made a vast amount of information available to everyone. However, searching for a specific information among millions of available documents could be tremendously time-consuming. The Internet is organized only by the name of each web site, wherein each individual or group maintaining the web site decides how that web site will be organized. Thus, anyone desiring information must hypothesize which web sites would be likely to have the desired data and navigate through those web sites according to the organization set up by the web site's operator. Although, some other databases and data stores are smaller, those many still exhibit the same organizational difficulties.

Currently, available portals for carrying out search include search engines. To use a search engine, a user provides a set of words to search for, and the search engine returns a list of “hits” or web sites containing those words. Although, search engines are advantageous since, they require little or no user input and/or or understanding of the operation of the search engine, that said the search engines may be difficult to work with for a number of reasons, such as, but not limited to, the list may contain a vast number of hits, few of which may actually relate to the desired piece of data. Further, conventional keyword searching returns any instance of the word being sought, regardless of the manner the word is used in the web site. Although, a user may add additional key words to narrow the search, often there exists no combination of words that must be found together to exclude all irrelevant pages while keeping all relevant ones. Furthermore, many conventional search engines return only the home page of a web site that contains the keyword. It is then up to the user to find the keyword in a site and determine whether it is relevant. Furthermore, a user may wish to supplement or rearrange the search results, but the way the results of a search are formatted typically makes addition or modification of criteria difficult or impossible.

The result of such a search through the internet or any database, is a list of results (or websites) that may be sorted in an alphabetical manner. For example, a list may be sorted using an existing search engine like, Google® search type algorithms, wherein most relevant items appear on the top of the list (based on keyword and criteria of web page reliability). However, there exist various problems with such types of search methods, such as, but not limited to, the result lists being based on relative ranking of the web pages (in the list) and thus does not work if the items in the list may not have anything in common. Moreover, if a user may not know how to classify the bit of information sought, he or she may not even be able to find it in the directory.

Therefore, in light of the foregoing discussion, there exists a need to overcome the aforementioned drawbacks and provide an improved system or method for ranking items in a list in view of a request.

### SUMMARY OF THE INVENTION

The present disclosure seeks to provide a system and a method for ranking items in a list in view of a request. In particular, the present disclosure seeks to provide a system and a method for ranking relevant classification codes (classes) for a trademark request. The present disclosure aims to provide a system and a method for ranking relevant classification codes (classes of goods and services) for a trademark request. Herein, the most relevant classification codes for the trademark request is ranked higher in comparison to the classification codes which is comparatively less relevant. An aim of the present disclosure is to provide a solution that overcomes at least partially the problems encountered in prior art.

In an aspect, the present disclosure provides a method for ranking items in a list in view of a request, using reference result sets obtained, respectively, by processing of information related to a plurality of reference entries, with each of the plurality of reference entries being associated with at least one of the items in the list, the method comprising:
processing the request to obtain a result set therefor;
determining a distance between the result set of the request and each of the reference result sets of the plurality of reference entries and the result set of the request;
determining a weight value for each of the reference result sets of the plurality of reference entries based on a maximum distance from the determined distances for the reference result sets of the plurality of reference entries; and
determining a rank score for each of the items in the list based on the weight values of the corresponding reference entries associated therewith.

In another aspect, a system for ranking items in a list in view of a request, the system comprising:
a database arrangement configured to store a plurality of reference entries and reference result sets obtained, respectively, by processing of information related to the plurality of reference entries, wherein each of the plurality of reference entries in the database arrangement is associated with at least one of the items in the list; and
a processing arrangement configured to:
   receive a request;
   process the request to obtain a result set therefor;
   determine a distance between each of the reference result sets of the plurality of reference entries and the result set of the request;
   determine a weight value for each of the result sets of the plurality of reference entries based on a maximum distance from the determined distances for the reference result sets of the plurality of reference entries; and
   determine a rank score for each of the items in the list based on the weight values of the corresponding reference entries associated therewith.

To overcome the aforementioned problems, the present disclosure provides a method and a system for ranking items in a list based on a context-based sorting of the list. The method comprises processing the request to obtain a related result set, determining a distance between each of the reference result sets of the reference entries, and the result set of the request, determining a weight value for each of the reference result sets of the reference entries based on the corresponding determined distance therefor (specifically, a maximum distance from the determined distances for the reference result sets of the plurality of reference entries), determining a rank score for each of the items in the list based on the weight values of the corresponding reference entries associated therewith. Herein, the distance between each of the reference result set of the reference entries with the result set of the request is divided by the maximum distance between any result set of the reference entries and the result set of the request to determine the weight value of the reference result sets of the plurality of reference entries.

The present method and system utilize a context-based sorting algorithm to utilize the available information and provide the most relevant results. Moreover, the present method and system also provide relevant keywords for each of the classes in order of relevancy (based on the context). The present method and system provide a quantifiable measure to determine the similarity between the result set of the reference entries and the request, and thus enables the comparison of the result set of the request or reference entries with respect to each other. Furthermore, the rank score of each of the items in the list is determined based on the determined weight value of the corresponding reference entries associated therewith.

There are known methods and systems for generating a search result list in response to a search request using implementation of distance between the results as well as assigning weights thereto for determining ranking for the results; however, none of the existing techniques teaches that weight value for each of the reference result sets of the plurality of reference entries is determined based on a maximum distance from the determined distances for the reference result sets of the plurality of reference entries, or in particular by dividing a maximum distance between any result set of the reference entries and the result set of the request to determine the weight value of the reference result sets of the plurality of reference entries.

Beneficially, the present method and system automatically generate classification for the requested data as well as automatically generate keywords used in each of the classes. The present method and system for ranking items in the list provide the results (classifications and/or keywords) with a higher accuracy attributed to the novel technique employed to determine the rankings for the items in the list. Further, the present method and system eliminate the need for user engagement and may determine the relevant results (classifications and/or keywords) without requiring any user input, and thus make the entire searching process faster.

Embodiments of the present disclosure substantially eliminate or at least partially address the aforementioned problems in the prior art and enable the system or method for ranking items in a list in view of a request.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a flowchart of a method for ranking items in view of a request, in accordance with an embodiment of the present disclosure;

FIG. 2 is a block diagram of a system for ranking items in view of a request, in accordance with another embodiment of the present disclosure;

FIG. 3 is a flow diagram for implementation of the method for ranking items in view of a request, in accordance with an embodiment of the present disclosure;

FIG. 4 is a diagrammatic representation of result sets of a plurality of reference entries, in accordance with an embodiment of the present disclosure;

FIG. 5 is a diagrammatic representation of the result sets of a request and the result sets of the plurality of reference entries, in accordance with an embodiment of the present disclosure;

FIG. 6 is a table for representing items for each of the result sets of the plurality of reference entries, in accordance with an embodiment of the present disclosure;

FIG. 7 is a table for representing distances, weight values and associated rank scores for each reference result set of the plurality of reference entries associated with the request, in accordance with an embodiment of the present disclosure;

FIG. 8 is a table representing similarity distances from the result set of the request to respective result sets of the plurality of reference entries, respective weighting values and their rank scores, in accordance with an embodiment of the present disclosure;

FIG. 9 is a table for representing a sorted list comprising ranks based on the rank score associated with each of the items on the list for the request, in accordance with an embodiment of the present disclosure;

FIG. 10 is a table representing determined distances from the result set of a request to respective result sets of the plurality of reference entries, associated items from the list, respective weighting values, and respective rank scores for each item on the list, in accordance with another embodiment of the present disclosure;

FIG. 11 is a table for representing rank scores for each item on the list associated with the request, in accordance with another embodiment of the present disclosure;

FIG. 12 is a table for representing a sorted list comprising ranks associated with each of the items on the list associated with the request, in accordance with another embodiment of the present disclosure;

FIG. 13 is a table for representing the items in the list associated with each result set of the plurality of reference entries, in accordance with another embodiment of the present disclosure;

FIG. 14 is a table for representing similarity distances from the result set of the request to respective result sets of the plurality of reference entries, respective weighting values and their determined rank scores, in accordance with another embodiment of the present disclosure; and

FIG. 15 is a table for representing rank scores for each of the result sets of the plurality of reference entries, associated items from the list, and respective rank scores for each item on the list, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates various aspects of the present disclosure and ways in which they can be implemented. Although some modes of carrying out the present disclosure have been disclosed, those skilled in the art would recognize that other embodiments for carrying out or practising the present disclosure are also possible.

The present disclosure provides a method for ranking items in a list. Generally, the method comprises context-based sorting of a list, wherein the sorting algorithm is selected based on the provided context. In an exemplary scenario, the method is configured to provide a list of most suitable services and product classes for any trademark application in order of relevancy (based on the context). The term “list” refers to a data-type configured to store the items to be ranked. However, it will be appreciated that the list is not limited to any specific data type and may include any one of arrays, binary, heaps, tables, trees, graphs etc. The ranking of items refers to deriving a relationship between the items in the list such that, for any two items, the first is either “ranked higher than”, “ranked lower than” or “ranked equal to” the second. Herein, the items in the list refers to classes or classifications (sometimes, also referred to as classification codes), determined using the method for any type of requested data. For example, a user may transmit a request comprising a trademark data, based on which the method may propose appropriate classification(s). Optionally, the items in the list are keywords, wherein the keywords may be used to form descriptions for the trademark request.

The present method is implemented for ranking items in a list in view of a request, using reference result sets obtained, respectively, by processing of information related to a plurality of reference entries, with each of the plurality of reference entries being associated with at least one of the items in the list. In operation, the method comprises receiving the plurality of reference entries, wherein the plurality of reference comprises information related to the plurality of reference entries. In an example, the method comprises receiving a trademark data from a trademark database, wherein the plurality of reference entries comprises at least one of a name of applicant, a trademark (name), classes and descriptions to each of the class for respective applicants/trademark. Upon receiving the plurality of reference entries, the method comprises processing the information related to the plurality of reference entries to obtain the reference result sets. Typically, the method comprises crawling a database or a web site, at least partly, associated with the trademark data and store the crawling results. In the present embodiments, each of the plurality of reference entries is associated with at least one of the items in the list. That is, for example, with the reference entries being entries of trademarks (as filed) in a trademark database, the items in the list would be the class(es) in which the respective trademark has been filed as per the corresponding record in the trademark database.

The method comprises processing the request to obtain a result set therefor. The request is received from a user device including information related to a new reference entry, wherein the new reference entry may be referred to as a user entry. The request from the user device is configured to propose a classification and a description for the associated user entry. The request may comprise a textual information related to service and/or products of interest. Alternatively, the request may comprise a URL to access a database or web site associated with the request or the user entry. In an example, another database or web site is crawled at least partially and the crawling results are stored in the database arrangement. Optionally, the textual information provided in the request may be used as crawling results.

In an embodiment, processing the request comprises data crawling of information related to the request. Typically, data crawling or web crawling refers to data extraction and data collection from either the world wide web, or in terms of data crawling, data extraction and data collection from any document, file, or database etc. Generally, web crawling is performed in large quantities, however, web crawling may be performed on smaller workloads as well.

The method further comprises determining a distance between each of the reference result sets of the plurality of reference entries and the result set of the request. That is, upon processing the request to obtain the result set therefor, the method further comprises utilizing the result sets from the reference entries to determine the distance between the result set each of the plurality of reference entries and the result set of the request. Generally, the determination of the distances between the result set of the request and each of the reference result sets is done via data clustering. In an example, the method comprises processing a first data, wherein the result sets based on the first data comprises at least three distinct results i.e., the first crawling results, the second crawling results, the third crawling results. In such a scenario, if the third crawling results are closer to the first crawling results than the second crawling results, in such cases, the method will set at least one item of the first data as the first ranked results.

In an embodiment, determining the distance comprises determining a similarity distance using one or more of: a clustering algorithm and a distance algorithm. Typically, the method comprises determining the similarity distance between the result set of the request and the result set of the plurality of reference entries. The “similarity distance” refers to a data mining process of determining a distance with dimensions representing features of two different objects. In case, the similarity distance is small, the two objects are deemed similar, whereas if the similarity distance is large, the objects indicate a low degree of similarity. Notably, the similarity distance provides the framework on which many data mining decisions, such as, classification and clustering are generally based on some similarity measure. Optionally, the clustering is done by at least one of, but not limited to, K-means clustering, Centroid-based Clustering, Density-based Clustering, Distribution-based Clustering, Hierarchical Clustering and so forth. Each of the web pages are associated with respective trademark data. Beneficially, the similarity distance enables the present method to quickly and efficiently search for the data and simplifies the overall operation.

The method further comprises determining a weight value for each of the reference result sets of the plurality of reference entries based on the corresponding determined distance therefor. In particular, the method comprises determining the weight value based on the similarity distance determined for each of the reference result sets of the plurality of reference entries. Typically, upon comparison of each of the determined similarity distances for each of the reference result sets of the plurality of reference entries, the weight value is assigned. The similarity distance is measured for each of the result set of the request with the result sets of the plurality of reference entries, and the weight value is assigned thereby. Generally, the weighting value is determined based on a pre-defined weighting formula, wherein the similarity distances are used for weight related classifications.

In an embodiment, determining the weight value comprises determining the weight value based on a maximum distance from the determined distances for the reference result sets of the plurality of reference entries. That is, the weight value is determined based on a maximum distance between the reference result sets of the plurality of reference entries with the result set of the request. In particular, herein, determining the weight value comprises determining the weight value by dividing a maximum distance between any result set of the reference entries and the result set of the request to determine the weight value of the reference result sets of the plurality of reference entries. That is, the distance between each of the plurality of reference entries of the result set with the result set of the request is divided by the maximum distance between any result set of the reference entries and the result set of the request to determine the weight value. The weight value indicates the similarity between the result set of the reference entries and the request and provides a quantifiable measure to determine the similarity, and thus enable comparison of the result set of the request or reference entries with respect to each other. The technical effect due to the aforementioned feature is that it provides a quantifiable measure to determine the similarity between the result set of the reference entries and the request, and thus enables the comparison of the result set of the request or reference entries with respect to each other.

In an exemplary scenario, for the weighting formula, distance between one of the result sets of the request (N1) to one of the result sets of the plurality of reference entries (A) as ‘N1A’ may be referred, and similarly, distance between N1 to another one of the result sets of the plurality of reference entries (B) as ‘N1B’ and so forth. Further, the maximum distance from the determined distances between the reference result sets of the plurality of reference entries and the result sets of the request (N1) may be referred to as ‘N1N’. Herein, for example, the weighting value (WN1A) of N1A and the weighting value (WN1B) of N1B is given by, WN1A=N1A/N1N and WN1B=N1A/N1N, respectively. In a generalized form, the weighting value for the result set of a request is given by the ratio of the determined distance between the results sets of the request and the plurality of reference entries and the maximum distance (i.e., distance to the furthest crawled web site). Using said weighting values, the method may determine the rank score for further determining which classes or classifications are most suitable for the request.

The method further comprises determining a rank score for each of the items in the list based on the weight values of the corresponding reference entries associated therewith. Typically, the rank score is determined for each of the items in the list based on the weight values of the corresponding reference entries associated therewith. In other words, for each of the classifications or items in the list, the rank score is determined based on the determined weight values of the corresponding reference entries associated herewith.

In an embodiment, the method further comprises sorting the items in the list based on the corresponding rank scores thereof. Typically, upon determining the rank score for each of the items on the list based on the weight values of the corresponding reference entries associated therewith, the items are sorted based on descending order, wherein the top item is the most suitable or relevant class or classification for the associated request and followed by the second item, the third item and so forth.

In an embodiment, the method further comprises recommending one or more items from the list having corresponding rank score being greater than a predefined threshold score. That is, upon determining the rank score for each of the items on the list based on the weight values of the corresponding reference entries associated therewith, one or items are recommended from the list based on the predefined threshold score. Herein, the “threshold score” refers to a minimum criterion for the items on the list to be recommended. The threshold score indicates a minimum level of rank score (indicating suitability) that must exist between the items on the list to the request, for the items to be considered recommendable. Typically, upon sorting the list, at least the top item on the list is recommended. However, there may exist a scenario, wherein no recommendations are made i.e., when the top item falls below the predefined threshold score and optionally, a message/alert may also be transmitted to indicate no recommendations.

In an embodiment, the method for ranking items in view of request is implemented in a scenario in which the request is a trademark request and the reference entries are trademark entries. Herein, the information related to the trademark entries comprise at least one of trademark title information, applicant name information, related website link information and trademark class description information. Further, the information related to the trademark request comprise at least one of trademark request title information, applicant name information, related website link information and trademark request details information.

In another embodiment, the items in the list comprise classification codes utilized for classification of the trademark entries.

In yet another embodiment, the items in the list comprise description keywords utilized for description of the trademark entries.

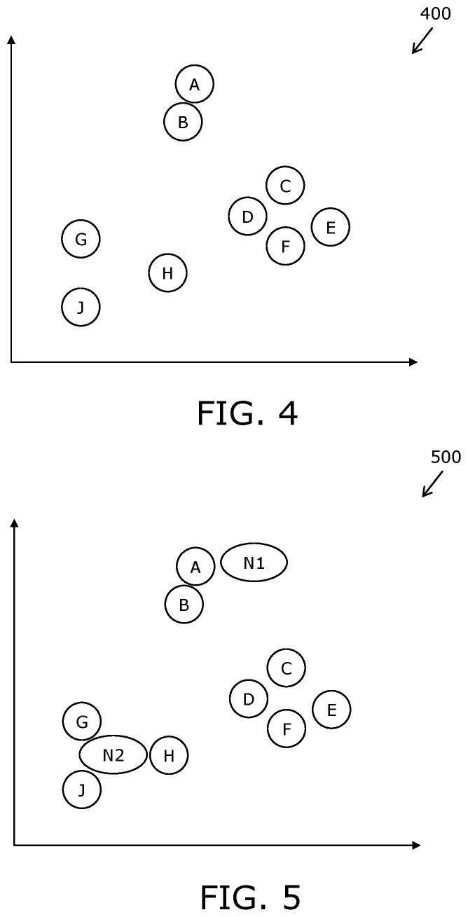

In an exemplary scenario, the method comprises clustering and crawling results for the plurality of reference entries, in accordance with an embodiment of the present disclosure. Referring to FIG. 4, illustrated are result sets of the plurality of reference entries, wherein each of the result sets of the plurality of reference entries are clustered based on the provided classifications, in accordance with an embodiment of the present disclosure. In the illustrated exemplary scenario, 9 distinct result sets of the plurality of reference entries generated using the present method are used for ranking items in a list. Herein, the result sets of the plurality of reference entries are named A, B, C, D, E, F, G, H, J. Further, one or more of the plurality of reference entries are clustered and may be associated with other data sets for further operation, using one or more of the clustering algorithm and the distance algorithm, as described above. Herein, the present method is employed to generate a new classification and related description. In operation, the results set of the plurality of reference entries i.e., the crawling data as generated by crawling the target web site is associated with a request. Optionally, the results set of the plurality of reference entries are generated by providing a text as an input, such as in cases wherein if a result set of the plurality of reference entries associated with the request is not functional, the result set or crawling data is analysed and mapped using a clustering algorithm. Similarly, a second result set or crawling data may be analysed and mapped for another request and so forth. Referring to FIG. 5, illustrated are result set of the request and the result sets of the plurality of reference entries, in accordance with an embodiment of the present disclosure. As shown, along with the results sets of the plurality of reference entries (A, B, C, D, E, F, G, H, J), the result sets of the request (N1, N2) are also mapped.

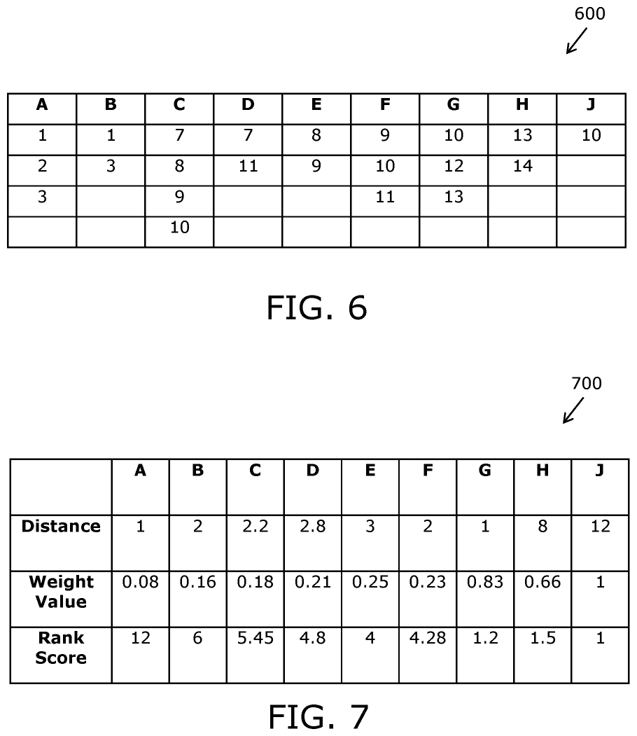

Referring to FIG. 6, illustrated is a table for representing items (or classes) for each of the result sets of the plurality of reference entries (A, B, C, D, E, F, G, H, J). As shown, each of the result sets of the plurality of reference entries is associated with the at least one item on the list, wherein the items on the list may be trademark classifications. Referring to FIG. 7, illustrated is a table representing similarity distances from the result set of the request (N1) to respective result sets of the plurality of reference entries (A-G), respective weighting values and their rank scores. Upon mapping the result set of the request and the result sets of the plurality of reference entries, the maximum similarity distance between the closest result set of the plurality of reference entries and to the farthest result set of the plurality of reference entries is determined. As shown, for request N1, result set A is closest and result set 3 is farthest from the request N1. Typically, the weighting formula is set in which the distances are used to weight related classifications. In an example, for weighting formula, we mark a first distance between N1 to A as N1A, a second distance between N1 to B as N1B and so forth to determine weighting values of WN1A=N1A/N1N, WN1B=N1A/N1N and so forth till WN1N=N1N/N1N=1. i.e., the first or second distance is divided by the maximum similarity distance to determine the weight value. Beneficially, said weighting values are utilized to determine which items on the list are best fit for N1. In operation, the determined weight values for each of the items in the list are utilized to determine rank scores or ranking points for each item. For example, since result sets A and B of the plurality of reference entries both comprises the item “1”, thus respective rank score for class 1 is equal to 12+6=18. Similarly, since only result set A comprises the class 2, the rank score for class 2 is equal to 12.

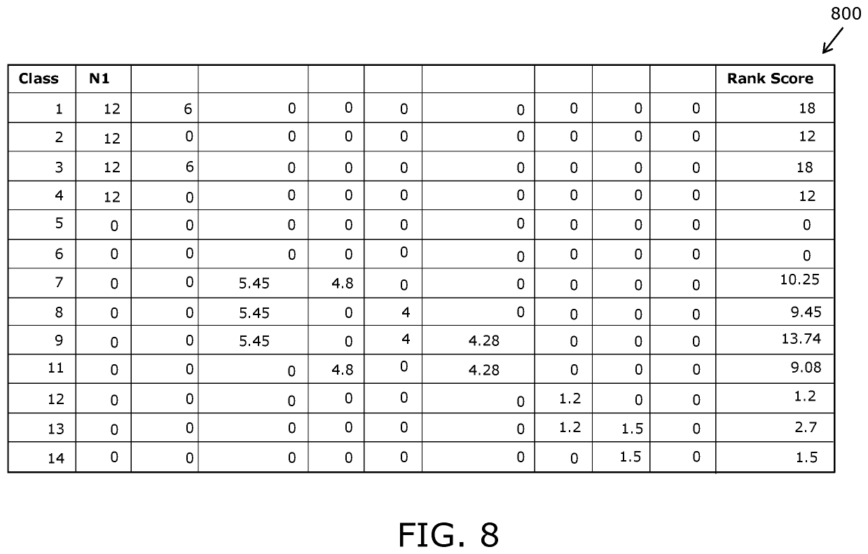

Referring to FIG. 8, illustrated is a table for representing rank scores for each item on the list associated with the request N1. Notably, such a table representing the rank scores for each item on the list associated with the request N1 enables the method to determine ranks for each of the items in the list based on the determined rank scores.

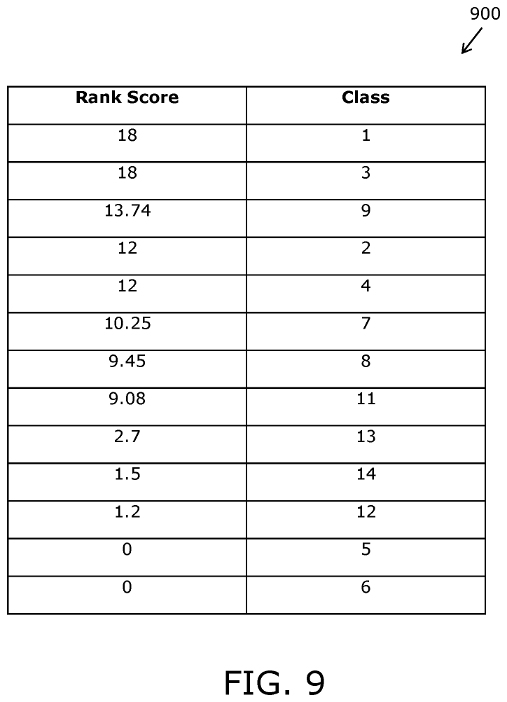

In an embodiment, the method comprises sorting the items on the list based on the determined rank or rank scores (as shown in FIG. 9). Referring to FIG. 9, illustrated is a table for representing a sorted list comprising ranks based on the rank score associated with each of the items on the list for the request (N1). Upon sorting the list based on the determined ranks, the method comprises recommending one or more items from the list. For example, the classifications recommended for request N1 are 1, 3 (equal rank) followed by 9 and then 2, 4 etc. Notably, the closest results sets of the plurality of reference entries (i.e., A and B) do not include class 9, and thus if any user attempts to identify suitable classes based on the request, the user may not be able to identify the relevant class 9 using the conventional methods and systems. To overcome the aforementioned problem, the present method provides a novel technique to provide the recommendations in a non-intuitive and novel manner, wherein the smart recommendations improves the accuracy of the results (i.e., the items on the list) and thus the overall efficiency of the method.

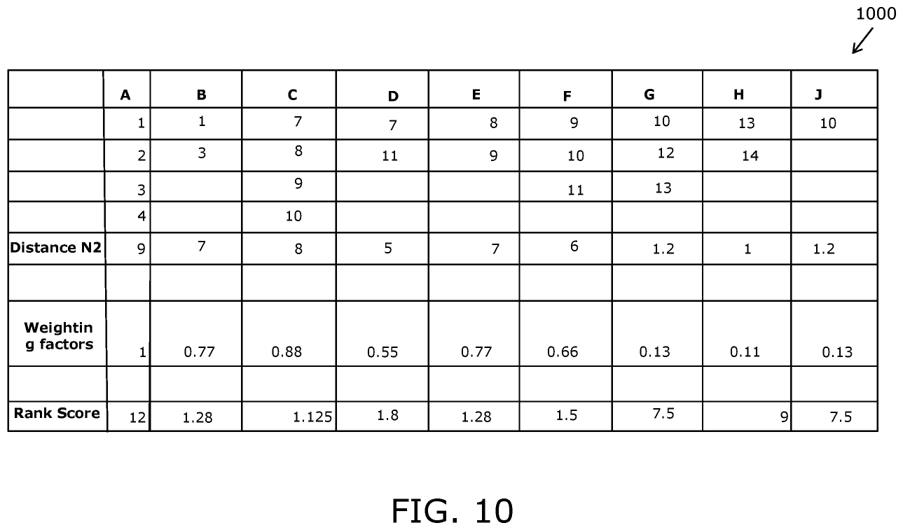

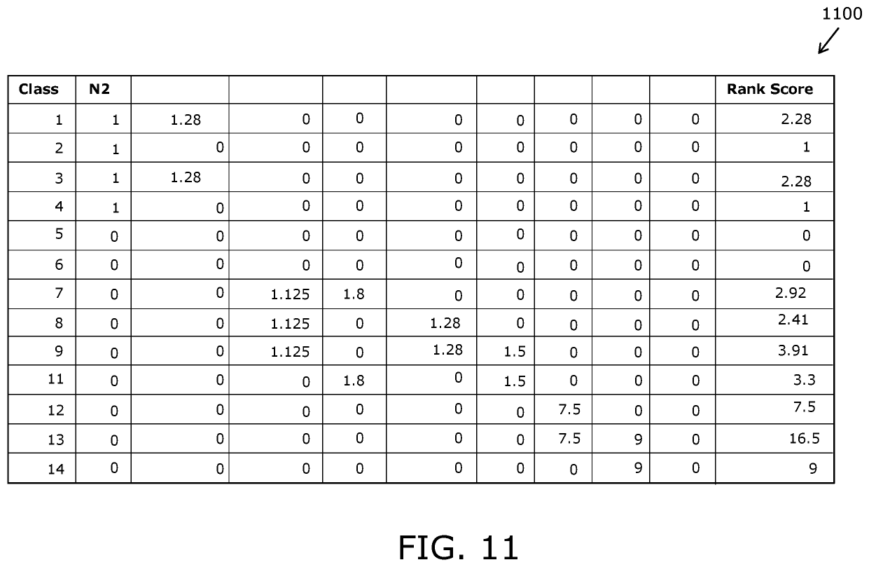

Similarly, for the request (N2, the same process may be applied). Referring to FIG. 10, illustrated is a table representing similarity distances from the result set of the request (N2) to respective result sets of the plurality of reference entries (A-G), associated items from the list, and respective weighting values and rank scores for each item on the list. Referring to FIG. 11, illustrated is a table for representing rank scores for each item on the list associated with the request (N2). Notably, such a table representing the rank scores for each item in the list associated with the request (N2) enables the method to determine ranks for each of the items in the list based on the determined rank scores.

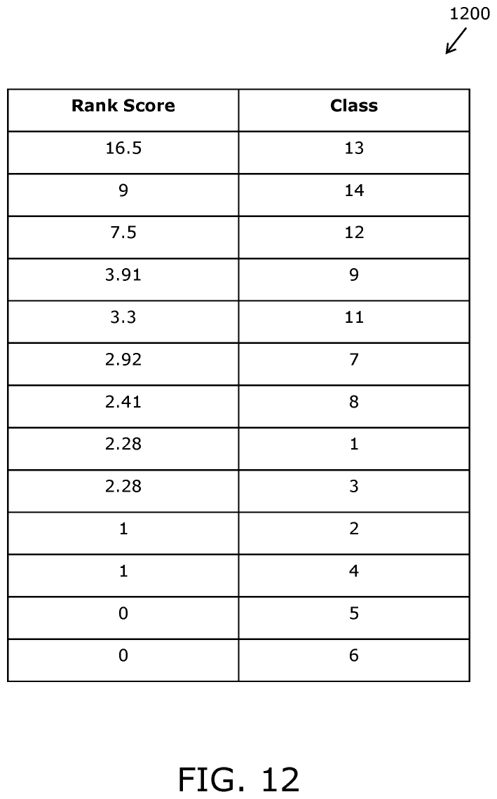

Optionally, the method comprises sorting the items on the list based on the determined rank or rank scores. Referring to FIG. 12, illustrated is a table for representing a sorted list comprising ranks associated with each of the items on the list for request (N2), in accordance with an embodiment of the present disclosure. As shown, the rank scores for each of the classes is provided in a descending order, and thus the top item (i.e., class 13) is the most relevant item for the request (N2).

Upon sorting the list based on the determined ranks, the method comprises recommending one or more items from the list. For example, the classifications for request N2 are 13, followed by 14, followed by 12 and them 9 and so forth. Notably, the closest results sets of the plurality of reference entries (i.e., G, H and J) includes the classes 9, 12, 13 and 14, indicating the high accuracy of the method.

In an embodiment, the method comprises providing relevant keywords for each of the items in the list based on an order of relevancy. In such an implementation, the method comprises automatically determining or generating a classification as well as automatically generating keywords associated with each of the items in the list. Typically, a similar logic is applied in the said analysis, wherein the weighting value is calculated for each keyword in the list and related results are obtained i.e., each item in the list is a keyword.

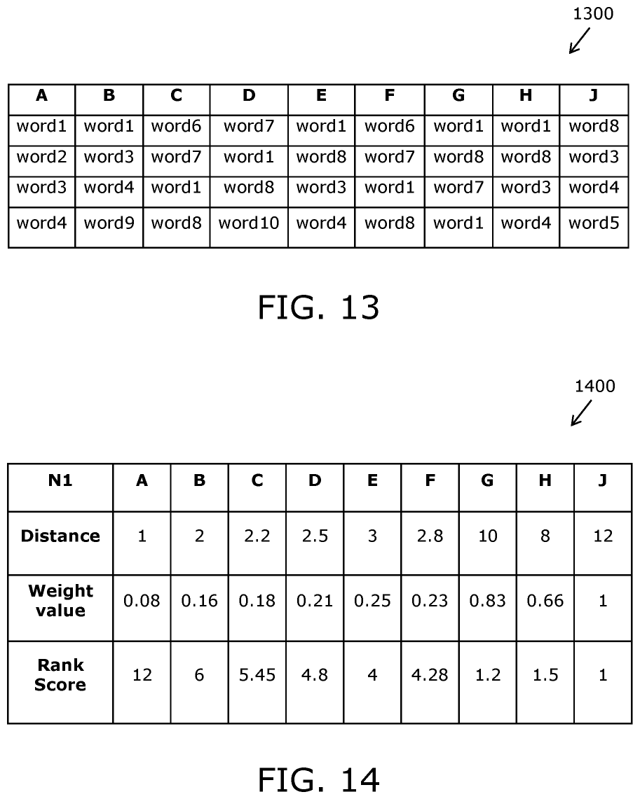

Referring to FIG. 13, illustrated is a table for representing the items (or keywords) in the list associated with each result set of the plurality of reference entries (A, B, C, D, E, F, G, H, J). Typically, the same process is followed by the method to determine the similarity distance and ranks score for the keywords as for the classes.

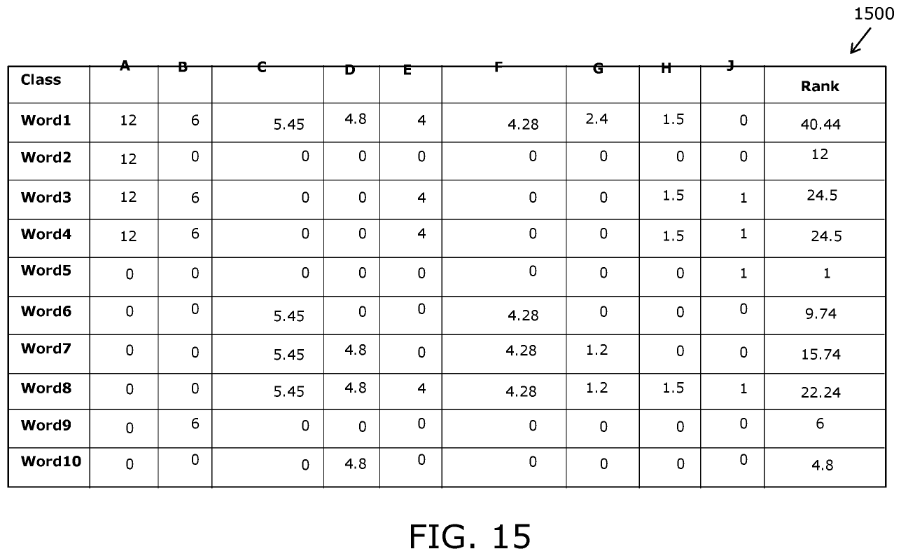

Referring to FIG. 14, illustrated is a table for representing similarity distances from the result set of the request (N1) to respective result sets of the plurality of reference entries (A, B, C, D, E, F, G, H, J), respective weighting values and their rank scores. Upon mapping the result set of the request (N1 or N2) and the result sets of the plurality of reference entries (A, B, C, D, E, F, G, H, J), the maximum similarity distance between the closest result set of the plurality of reference entries and to the farthest result set of the plurality of reference entries is determined. As shown, for request N1, result set A is closest and result set J is farthest from the request N1. Typically, the weighting formula is set in which the distances are used for keyword related classifications. In an example, for weighting formula, we mark a first distance between N1 to A as N1A, a second distance between N1 to B as N1B and so forth to determine weighting values of WN1A=N1A/N1N, WN1B=N1A/N1N and so forth till WN1N=N1N/N1N=1. i.e., the first or second distance is divided by the maximum similarity distance to determine the weight value. Beneficially, said weighting values are utilized to determine which items or keywords on the list are best fit for N1.

Referring to FIG. 15, illustrated is a table for representing similarity distances from the result set of the request (N1) to respective result sets of the plurality of reference entries (A, B, C, D, E, F, G, H, J), associated items from the list, and respective weighting values and rank scores for each item on the list. Upon determining the rank score for each keyword on the list, the method comprises recommending one or more keywords. Herein, the method may recommend at least the items or keywords words word1, word3, word4 and word 8 based on the request (N1). Such an implementation of the method provides the most relevant keywords to be recommended to a user based on their respective relevancy in a highly accurate and efficient manner.

In an embodiment, the method comprises allowing a user to preset proposed items on the list. Herein, the method comprises sorting the list in a descending rank order and allow to select which of the items on the list are to be included. For example, the method allows selection of one or more items from the list i.e., the proposed keywords or classes as items on the list.

In another embodiment, the method comprises using the selected items on the list to file a trademark. In an example, upon selecting the one or more items from the list, the trademark is filed using the selected items i.e., the proposed classifications and/or keywords.

The present disclosure also provides a system for ranking items in a list in view of a request. The system comprises a database arrangement configured to store a plurality of reference entries and reference result sets obtained, respectively, by processing of information related to the plurality of reference entries, wherein each of the plurality of reference entries in the database arrangement is associated with at least one of the items in the list. Further, the system comprises a processing arrangement configured to receive a request, process the request to obtain a result set therefor, determine a distance between each of the reference result sets of the plurality of reference entries and the result set of the request, determine a weight value for each of the result sets of the plurality of reference entries based on a maximum distance from the determined distances for the reference result sets of the plurality of reference entries, and determine a rank score for each of the items in the list based on the weight values of the corresponding reference entries associated therewith.

Herein, the ‘processing arrangement’ (or the data processing arrangement) refers to a structure and/or module that includes programmable and/or non-programmable components configured to store, process and/or share information and/or signals relating to the ranking of the items in the list. The processing arrangement may be a controller having elements, such as a display, control buttons or joysticks, processors, memory and the like. Typically, the data processing arrangement is operable to perform one or more operations for ranking the items in the list in view of request. In the present examples, the data processing arrangement may include components such as memory, a processor, a network adapter and the like, to store, process and/or share information with other computing components, such as a user device, a remote server unit, a database arrangement.

Optionally, the processing arrangement may be implemented as a remote server. The “remote server” refers to a structure and/or module that includes programmable and/or non-programmable components configured to store, process and/or share information or data for ranking the items in the list in view of request. Optionally, the remote server includes any arrangement of physical or virtual computational entities capable of enhancing information to perform various computational tasks.

Furthermore, it will be appreciated that the remote server may be implemented as a hardware server and/or plurality of hardware servers operating in a parallel or in a distributed architecture. Optionally, the remote server is supplemented with additional computation system, such as neural networks, and hierarchical clusters of pseudo-analog variable state machines implementing artificial intelligence algorithms. In an example, the remote server may include components such as a memory, a processor, a data communication interface, a network adapter and the like, to store, process and/or share information with other computing devices, such as the data processing arrangement, the database arrangement, a user device. Optionally, the remote server is implemented as a computer program that provides various services (such as database service) to other devices, modules or apparatus. Moreover, the remote server refers to a computational element that is operable to respond to and processes instructions to perform the ranking of items in the list in view of the request. Optionally, the remote server includes, but is not limited to, a microprocessor, a microcontroller, a complex instruction set computing (CISC) microprocessor, a reduced instruction set (RISC) microprocessor, a very long instruction word (VLIW) microprocessor, Field Programmable Gate Array (FPGA) or any other type of processing circuit, for example as aforementioned. Additionally, the remote server is arranged in various architectures for responding to and processing the instructions for ranking the items in the list in view of request via the method or system. Herein, the system elements may communicate with each other using a communication interface. The communication interface includes a medium (e.g., a communication channel) through which the system components communicates with each other. Examples of the communication interface include, but are not limited to, a communication channel in a computer cluster, a Local Area Communication channel (LAN), a cellular communication channel, a wireless sensor communication channel (WSN), a cloud communication channel, a Metropolitan Area Communication channel (MAN), and/or the Internet. Optionally, the communication interface comprises one or more of a wired connection, a wireless network, cellular networks such as 2G, 3G, 4G, 5G mobile networks, and a Zigbee connection.

In an embodiment, the processing arrangement is configured to process the request by data crawling of information related to the request.

In another embodiment, the processing arrangement is configured to determine the distance by determining a similarity distance using one or more of: a clustering algorithm and a distance algorithm.

In yet another embodiment, the processing arrangement is configured to determine the weight value by dividing a maximum distance between any result set of the reference entries and the result set of the request to determine the weight value of the reference result sets of the plurality of reference entries.

In yet another embodiment, the processing arrangement is further configured to sort the items in the list based on the corresponding rank scores thereof.

In an embodiment, the processing arrangement is further configured to recommend one or more items from the list having corresponding rank score greater than a predefined threshold score.

The present system may be implemented for ranking items in the list in which the request is a trademark request and the reference entries are trademark entries. Herein, the information related to the trademark entries comprise at least one of trademark title information, applicant name information, related website link information and trademark class description information. Also, herein, the information related to the trademark request comprise at least one of trademark request title information, applicant name information, related website link information and trademark request details information.

In an embodiment, the items in the list comprise classification codes utilized for classification of the trademark entries.

In another embodiment, the items in the list comprise description keywords utilized for description of the trademark entries.

The present disclosure also provides a computer-readable storage medium comprising instructions which, when executed by a computer, cause the computer to carry out the steps of the method for ranking the items in the list in view of request. Furthermore, the present disclosure can take the form of a computer program product comprising computer executable program code, when executed the program code controls a computer to carry out the steps of the method for ranking the items in the list in view of request. Herein, the computer program product may be accessible from a computer-readable storage medium providing program code for use by or in connection with a computer or any instruction execution system. Examples of implementation of the non-transitory computer-readable storage medium include, but is not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

### DETAILED DESCRIPTION OF DRAWINGS

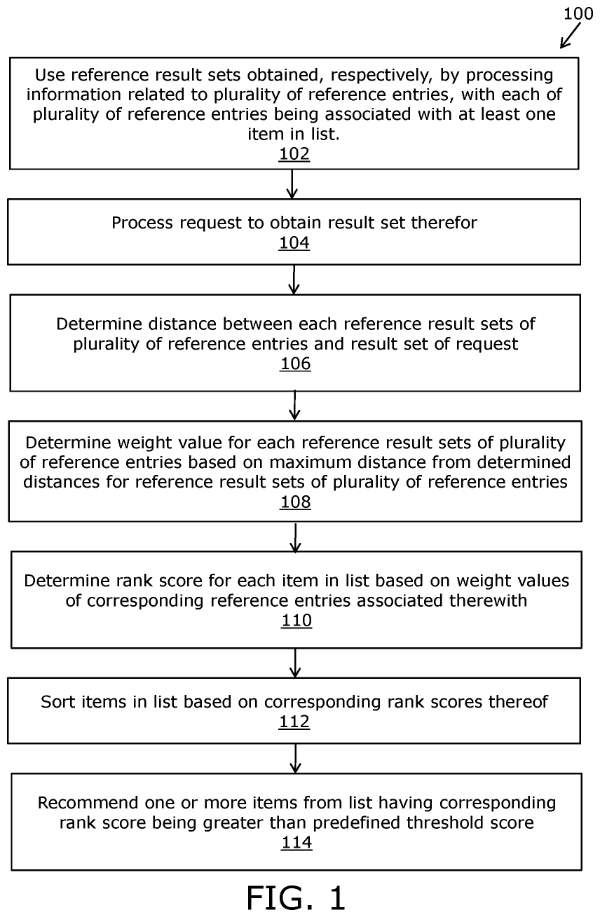

Referring to FIG. 1, illustrated is a flowchart of a method 100 for ranking items in a list in view of a request, in accordance with an embodiment of the present disclosure. As shown, the method 100 comprises steps 102, 104, 106, 108, 110, 112, and 114.

At step 102, the method 100 comprises using reference result sets obtained, respectively, by processing of information related to a plurality of reference entries, with each of the plurality of reference entries being associated with at least one of the items in the list. Typically, the method 100 comprises processing information related to the plurality of reference entries to generate reference result sets stored in the database arrangement. Further, the method 100 comprises associating each of the reference result sets with at least one item on the list. Additionally, descriptions for the classes are associated with crawling results. Notably, at step 102 is a pre-work operation (also referred as training, if the association is done using machine learning or artificial intelligence algorithms) that are needed to ensure operation of the database arrangement.

At step 104, the method 100 comprises processing the request to obtain a result set therefor. Upon receiving the request, the request is processed to generate the result sets of the request. The result sets of the request are mapped along with the result sets of the plurality of reference entries for further operation.

At step 106, the method 100 comprises determining a distance between each of the reference result sets of the plurality of reference entries and the result set of the request. The method 100 comprises determining the similarity distance between each of the reference result sets of the plurality of reference entries and the result set of the request, wherein the similarity distance indicates a level or degree of similarity.

At step 108, the method 100 comprises determining a weight value for each of the reference result sets of the plurality of reference entries based on a maximum distance from the determined distances for the reference result sets of the plurality of reference entries. Upon determining the distance for each of the reference result sets of the plurality of reference entries based, the method 100 comprises utilizing the determined distance to determine the weight value for each of the reference result sets. Herein, the weight value is determined by dividing a maximum distance between any result set of the reference entries and the result set of the request to determine the weight value of the reference result sets of the plurality of reference entries.

At step 110, the method 100 comprises determining a rank score for each of the items in the list based on the weight values of the corresponding reference entries associated therewith. Upon determining the weight value, the method 100 comprises utilizing the determined weight values to determine the ranks score for each of the items in the list based on the weight values (or rank score) of the corresponding reference entries associated therewith.

Optionally, at step 112, the method 100 comprises sorting the items on the list based on the determined rank scores for each item on the list.

Optionally, at step 114, the method 100 comprises recommending one or more items from the list based on a predefined threshold score.

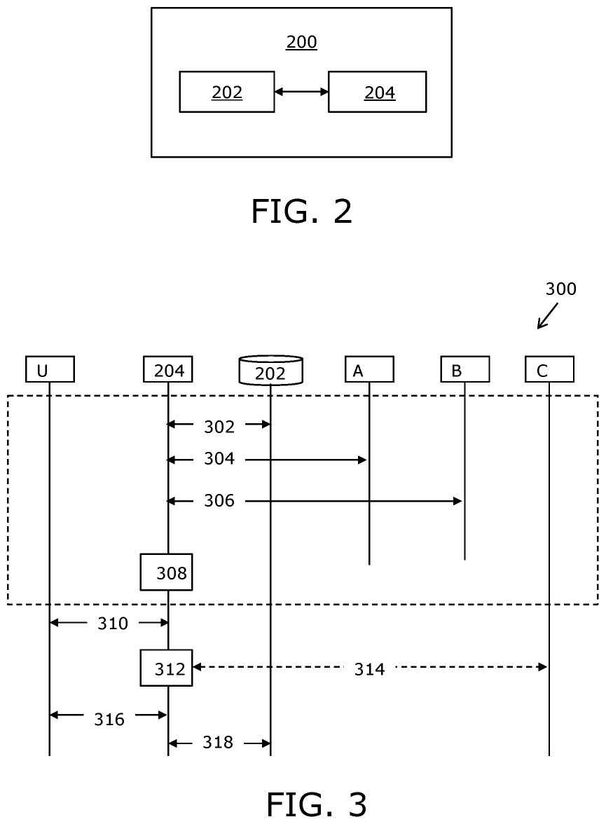

Referring to FIG. 2, illustrated is a block diagram of a system 200 for ranking items in a list in view of a request, the system 200 comprising a database arrangement 202 configured to store a plurality of reference entries and reference result sets obtained, respectively, by processing of information related to the plurality of reference entries, wherein each of the plurality of reference entries in the database arrangement 202 is associated with at least one of the items in the list. The system 200 further comprises a processing arrangement 204 configured to receive a request, process the request to obtain a result set therefor, determine a distance between each of the reference result sets of the plurality of reference entries and the result set of the request. Further, the processing arrangement 204 is configured to determine a weight value for each of the results set of the plurality of reference entries based on the corresponding determined distance therefor and determine a rank score for each of the items in the list based on the weight values of the corresponding reference entries associated therewith.

Referring to FIG. 3, illustrated is a detailed high-level flow diagram 300 for implementation of the method 100, in accordance with an embodiment of the present disclosure. As shown, the method 100 comprises steps 302, 304, 306, 308, 310, 312, 314 and 316. As shown, at a step 302, the information related to a plurality of reference entries is processed. In an example, the database arrangement crawls, at least partly, a first result set A associated to one of the plurality of reference entries. At a step 304, result sets obtained by pre-processing the reference entry in the database arrangement are stored. At a step 306, ranking rules to associate the reference entry with at least one item on the list are determined. Additionally, descriptions for the classes are associated with crawling results. Further, at step 308, the reference result sets are clustered to determine a similarity distance between the reference entries A, B. Notably, steps 302-308 (marked with dashed square) are pre-work operations (also referred as training if the association is done using machine learning or artificial intelligence algorithms) that are needed to ensure operation of the database arrangement. After the pre-work is completed, the data processing arrangement may be used to generate and accordingly rank the items on the list. At step 310, the method 100 comprises processing the request received from a user U to obtain a result set therefor. The result sets of the request are mapped along with the result sets of the plurality of reference entries for further operation. At step 312, a distance between each of the reference result sets of the plurality of reference entries (shown as A and B) and the result set of the request are determined. Further, optionally, the method 100 comprises crawling a third website C to determine the reference result set of the plurality of reference entries. Further, at steps 314, 316, a weight value for each of the reference result sets of the plurality of reference entries based on the corresponding determined distance therefor are determined. Furthermore, at step 318, upon determining the weight value, the method 100 comprises utilizing the determined weight values to determine the ranks score for each of the items in the list based on the weight values of the corresponding reference entries associated therewith.

Referring to FIG. 4, illustrated is a graph 400 with the result sets of the plurality of reference entries, wherein each of the result sets of the plurality of reference entries are clustered based on the provided classifications, in accordance with an embodiment of the present disclosure. As shown, the result sets of the plurality of reference entries comprises the result set A, result set B, result set C, result set D, result set E, result set F, result set G, result set H, result set J, wherein based on their provided information related to the plurality of reference entries, the result sets are clustered together.

Referring to FIG. 5, illustrated is a graph 500 with the result sets of a request N1 and the result sets of the plurality of reference entries, in accordance with an embodiment of the present disclosure. As shown, along with the results sets of the plurality of reference entries, i.e., the result sets A, B, C, D, E, F, G, H, J, the result set of the request N1, N2 are also mapped.

Referring to FIG. 6, illustrated is a table 600 for representing items for each of the result sets of the plurality of reference entries, in accordance with an embodiment of the present disclosure. As shown, each of the result sets of the plurality of reference entries A, B, C, D, E, F, G, H, J is associated with the at least one item (or class) on the list, wherein the items on the list may be trademark classifications.

Referring to FIG. 7, illustrated is a table 700 for representing distances, weight values and associated rank scores for each reference result set of the plurality of reference entries associated with the request N1, in accordance with an embodiment of the present disclosure. Notably, such a table representing the weight values for each item on the list associated with the request N1 enables the method to determine rank score for each of the result sets of the plurality of reference entries A, B, C, D, E, F, G, H, J based on the determined weight values. Typically, the rank score for each result set is the inverse value of the weight value. For example, weight value of result set A is 0.0833 and thus the respective rank score is 12.

Referring to FIG. 8, illustrated is a table 800 representing similarity distances from the result set of the request N1 to respective result sets of the plurality of reference entries A, B, C, D, E, F, G, H, J, respective weighting values and their rank scores, in accordance with an embodiment of the present disclosure. Typically, the rank score for each result set of the plurality of reference entries is added to determine the rank score for each of the items on the list, i.e., if the corresponding item is present in any of the result sets of the plurality of reference entries. For example, Class 1 is present in both result sets A and B, thus the rank score for class 1 is determined by adding rank score of A (i.e., 12 units) and rank score of B (i.e., 6 units) to determine the rank score for class 1 as 18 units.

Referring to FIG. 9, illustrated is a table 900 for representing a sorted list comprising ranks based on the rank score associated with each of the items on the list for the request N1, in accordance with an embodiment of the present disclosure. As shown, in an embodiment, the method 100 comprises sorting the items on the list based on the determined rank or rank scores in a descending order i.e., the top items (class 1 and class 3) on the list having the maximum rank scores (18 units) are the most relevant or recommendable. For example, the classifications recommended for request N1 are 1, 3 (equal rank) followed by 9 and then 2, 4 etc. Notably, the closest results sets of the plurality of reference entries (i.e., A and B) do not include class 9, and thus if any user attempts to identify suitable classes based on the request, the user may not be able to identify the relevant class 9 using the conventional methods and systems. To overcome the aforementioned problem, the present method provides a novel technique to provide the recommendations in a non-intuitive and novel manner, wherein the smart recommendations improves the accuracy of the results (i.e., the items on the list) and thus the overall efficiency of the method.

Referring to FIG. 10, illustrated is a table 1000 representing determined distances from the result set of a request N2 to respective result sets of the plurality of reference entries A, B, C, D, E, F, G, H, J, associated items from the list, respective weighting values, and respective rank scores for each item on the list, in accordance with an embodiment of the present disclosure.

Referring to FIG. 11, illustrated is a table 1100 for representing rank scores for each item on the list associated with the request N2, in accordance with an embodiment of the present disclosure. Notably, the table 1100 representing the rank scores for each item in the list associated with the request N2 enables the method to determine ranks (or rank scores) for each of the items in the list based on the determined rank scores.

Referring to FIG. 12, illustrated is a table 1200 for representing a sorted list comprising ranks associated with each of the items on the list associated with the request N2, in accordance with an embodiment of the present disclosure. As shown, the rank scores for each of the classes is provided in a descending order, and thus it may be understood that the top item (i.e., class 13) is the most relevant item for the request N2.

Referring to FIG. 13, illustrated is a table 1300 for representing the items (or keywords) in the list associated with each result set of the plurality of reference entries A, B, C, D, E, F, G, H, J, in accordance with an embodiment of the present disclosure. Typically, the same process is followed by the method 100 to determine the similarity distance and ranks score for the keywords as performed previously for determining the relevant classes.

Referring to FIG. 14, illustrated is a table 1400 for representing similarity distances from the result set of the request (N2) to respective result sets of the plurality of reference entries A, B, C, D, E, F, G, H, J, respective weighting values and their determined rank scores, in accordance with an embodiment of the present disclosure. As shown, these values are used by the method 100 to determine the rank scores for each result set of the plurality of reference entries A, B, C, D, E, F, G, H, J. Typically, the rank score is the inverse of the weight value for any of the result set of the plurality of reference entries.

Referring to FIG. 15, illustrated is a table 1500 for representing rank scores for each of the result sets of the plurality of reference entries A, B, C, D, E, F, G, H, J, associated items from the list, and respective rank scores for each item on the list, in accordance with an embodiment of the present disclosure. As shown, the rank score for each result set of the plurality of reference entries is added to determine the rank score for each of the items (or keywords) on the list, i.e., if the corresponding item is present in any of the result sets of the plurality of reference entries. For example, word1 is present in the result sets A, B, C, D, E, F, G, H, thus the rank score for word 1 is determined by adding rank score of A (i.e., 12 units) and rank score of B (i.e., 6 units) and so forth till rank score for H (i.e., 1.5 units) and thus the total rank score for class 1 is 40.4402597. Such an implementation of the method 100 provides the most relevant keywords to be recommended to a user based on their respective relevancy in a highly accurate and efficient manner.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for ranking items in a list in view of a request (N1, N2), using reference result sets obtained, respectively, by processing of information related to a plurality of reference entries (A, B, C, D, E, F, G, H, J), with each of the plurality of reference entries being associated with at least one of the items in the list, the method comprising:
processing the request (N1, N2) to obtain a result set therefor;
determining a distance between each of the reference result sets of the plurality of reference entries (A, B, C, D, E, F, G, H, J) and the result set of the request;
determining a weight value for each of the reference result sets of the plurality of reference entries (A, B, C, D, E, F, G, H, J) based on a maximum distance from the determined distances for the reference result sets of the plurality of reference entries (A, B, C, D, E, F, G, H, J); and
determining a rank score for each of the items in the list based on the weight values of the corresponding reference entries associated therewith.

2. The method according to claim 1, wherein processing the request comprises data crawling of information related to the request.

3. The method according to claim 1, wherein determining the distance comprises determining a similarity distance using one or more of: a clustering algorithm and a distance algorithm.

4. The method according to claim 1, wherein determining the weight value comprises determining the weight value by dividing a maximum distance between any result set of the reference entries (A, B, C, D, E, F, G, H, J) and the result set of the request to determine the weight value of the reference result sets of the plurality of reference entries (A, B, C, D, E, F, G, H, J).

5. The method according to claim 1, further comprising sorting the items in the list based on the corresponding rank scores thereof.

6. The method according to claim 1 further comprising, recommending one or more items from the list having corresponding rank score being greater than a predefined threshold score.

7. The method according to claim 1, wherein:
the request (N1, N2) is a trademark request and the reference entries are trademark entries,
the information related to the trademark entries comprise at least one of trademark title information, applicant name information, related website link information and trademark class description information, and
the information related to the trademark request comprise at least one of trademark request title information, applicant name information, related website link information and trademark request details information.

8. The method according to claim 7, wherein the items in the list comprise classification codes utilized for classification of the trademark entries.

9. The method according to claim 7, wherein the items in the list comprise description keywords utilized for description of the trademark entries.

10. A system for ranking items in a list in view of a request (N1, N2), the system comprising:
a database arrangement configured to store a plurality of reference entries and reference result sets obtained, respectively, by processing of information related to the plurality of reference entries (A, B, C, D, E, F, G, H, J), wherein each of the plurality of reference entries in the database arrangement is associated with at least one of the items in the list; and
a processing arrangement configured to:
receive a request (N1, N2);
process the request to obtain a result set therefor;
determine a distance between each of the reference result sets of the plurality of reference entries (A, B, C, D, E, F, G, H, J) and the result set of the request;
determine a weight value for each of the result sets of the plurality of reference entries based on a maximum distance from the determined distances for the reference result sets of the plurality of reference entries (A, B, C, D, E, F, G, H, J); and
determine a rank score for each of the items in the list based on the weight values of the corresponding reference entries associated therewith.

11. The system according to claim 10, wherein the processing arrangement is configured to process the request (N1, N2) by data crawling of information related to the request (N1, N2).

12. The system according to claim 10, wherein the processing arrangement is configured to determine the distance by determining a similarity distance using one or more of: a clustering algorithm and a distance algorithm.

13. The system according to claim 10, wherein the processing arrangement is configured to determine the weight value by dividing a maximum distance between any result set of the reference entries (A, B, C, D, E, F, G, H, J) and the result set of the request to determine the weight value of the reference result sets of the plurality of reference entries (A, B, C, D, E, F, G, H, J).

14. The system according to claim 10, wherein the processing arrangement is further configured to sort the items in the list based on the corresponding rank scores thereof.

15. The system according to claim 10, wherein the processing arrangement is further configured to recommend one or more items from the list having corresponding rank score greater than a predefined threshold score.

16. The system according to claim 10, wherein:
the request (N1, N2) is a trademark request and the reference entries are trademark entries,
the information related to the trademark entries comprise at least one of trademark title information, applicant name information, related website link information and trademark class description information, and
the information related to the trademark request comprise at least one of trademark request title information, applicant name information, related website link information and trademark request details information.

17. The system (2200) according to claim 16, wherein the items in the list comprise classification codes utilized for classification of the trademark entries.

18. The system (2200) according to claim 16, wherein the items in the list comprise description keywords utilized for description of the trademark entries.

19. A computer-readable storage medium comprising instructions which, when executed by a computer, cause the computer to carry out the steps of the method according to claim 1.

20. A computer program product comprising computer executable program code, when executed the program code controls a computer to carry out the steps of the method according to claim 1.
